(19) United States
(12) Patent Application Publication
(10) Pub. No.: US 2023/0330897 A1
(43) Pub. Date: Oct. 19, 2023

(54) RESIN PELLET, METHOD OF ITS MANUFACTURING, AND MOLDED PRODUCT THEREOF

(71) Applicants: THE CHEMOURS COMPANY FC, LLC, WILMINGTON, DE (US); Chemours-Mitsui Fluoroproducts Co. Ltd., MINATO-KU, TOKYO (JP)

(72) Inventors: HIROMASA YABE, SHIZUOKA (JP); KATSUYA ASAZUMA, SHIZUOKA (JP)

(73) Assignees: THE CHEMOURS COMPANY FC, LLC, WILMINGTON, DE (US); CHEMOURS-MITSUI FLUOROPRODUCTS CO. LTD., MINATO-KU, TOKYO (JP)

(21) Appl. No.: 18/019,502

(22) PCT Filed: Aug. 2, 2021
(86) PCT No.: PCT/US2021/044151

§ 371 Date: Feb. 3, 2023

(30) Foreign Application Priority Data
Aug. 3, 2020 (JP) 2020-131774

(51) Int. Cl. B29B 9/16

(52) U.S. Cl. CPC B29B 9/16; B29K 2027/18

(57) ABSTRACT

To provide a resin pellet that is suitable for molding a molded product used in a semiconductor manufacturing apparatus and inherently has high cleanliness, and a molded product including the resin pellets used in a semiconductor manufacturing apparatus.

A resin pellet including at least one selected from tetrafluoroethylene homopolymers or copolymers, wherein the evaporation residue after evaporating and drying the extract obtained by dissolving and extracting the fluorine-containing substance contained in or adhering to the resin pellet in a fluorine-containing extractant is 20×10⁻⁶ mg/mm² or less.

### CROSS REFERENCE TO RELATED APPLICATION

This application claims priority to the following Japanese patent application no. JP2020-131774, filed Aug. 3, 2020, the disclosure of which is incorporated herein by reference in its entirety.

### BACKGROUND OF THE INVENTION

The present invention relates to resin pellets that are suitable for molding a molded product used in a semiconductor manufacturing apparatus, and a molded product that is molded from the resin pellets and used in a semiconductor manufacturing apparatus, such as a molded product for liquid transfer and/or liquid contact.

As the circuit pattern of semiconductor devices becomes finer, higher in density, more integrated, and the number of layers of wiring increases, the production process becomes more complicated and the number of steps continues to increase. As a result, the size of defects in the circuit pattern of semiconductor devices is becoming smaller and smaller. For this reason, the materials and processes themselves used in a semiconductor manufacturing apparatus may be the source of contamination, and particles (foreign particles), metal impurities, chemical contaminants, and other minute (minimum) contaminants at semiconductor manufacturing sites have an increasingly large effect on the yield and reliability of semiconductor products. (Non-Patent Document 1). In the case of particles, because even fine particles of submicron size can cause defects that lead to failures if adhered to the wafer surface, it is necessary to even remove submicron particles. Therefore, in order to suppress the occurrence of circuit pattern defects in fine semiconductor devices and reduce particles larger than the circuit pattern size, cleanliness (low particles and low metals) of materials and processes used in a semiconductor manufacturing apparatus that prevents particles from adhering to wafers is becoming increasingly important.

In a semiconductor manufacturing apparatus, the use of fluororesin molded products utilizing the characteristics of fluororesin is increasing. However, particles (contaminant fine particles) easily adhere to the surface of the fluororesin molded product, and it is not easy to remove even submicron-sized fine particles that adhere to the wafer surface to cause defects that lead to failures. However, these methods require a long time for cleaning, and it is difficult to reach a level of cleanliness that meets the requirements for fluororesin molded products used in a semiconductor manufacturing apparatus.

Therefore, a treatment method for removing fine particles adhering to a fluororesin molded product used in semiconductor manufacturing has been proposed (Patent Document 1). However, the processing method proposed in Patent Document 1 requires a special device for implementation and cannot be implemented by a simple means, and has difficulty in reaching a level of cleanliness sufficient to meet the requirements for fluororesin molded products used in semiconductor manufacturing.

Further, the chemical solution used for cleaning the fluororesin molded product used in the semiconductor manufacturing apparatus has a problem that its cost and environmental load are high.

### DESCRIPTION OF RELATED ART

Patent Document 1: Japanese Unexamined Patent Application Publication No. H08-005140.
Patent Document 2: Japanese Unexamined Patent Application Publication No. 2012-518010.
Non-Patent Document 1: “New Edition Silicon Wafer Surface Cleaning Technology”, Realize Corporation, published in 2000, by Takeshi Hattori.

### SUMMARY OF THE INVENTION

As a result of diligent research in order to solve the above-described problems of the prior art, the present inventors have found resin pellets inherently having high cleanliness used for molding a molded product used in a semiconductor manufacturing apparatus, and has accomplished the present invention.

The present invention also provides a molded product that includes the resin pellets used in a semiconductor manufacturing apparatus, and inherently has high cleanliness.

### Means for Resolving Problems

The present invention provides resin pellets having high cleanliness used for molding a molded product used in a semiconductor manufacturing apparatus, the resin pellets containing at least one selected from tetrafluoroethylene homopolymers or copolymers, wherein the evaporation residue after evaporating and drying the extract obtained by dissolving and extracting the fluorine-containing substance contained in or adhering to the resin pellets in a fluorine-containing extractant is 20×10⁻⁶ mg/mm² or less.

A preferred embodiment of the resin pellets of the present invention is as follows:
(1) the evaporation residue is in the range of from 0 to 10×10⁻⁶ mg/mm²;
(2) the evaporation residue is in the range of from 0 to 1.0×10⁻⁶ mg/mm²;
(3) the tetrafluoroethylene (TFE) copolymer is at least one of a TFE/hexafluoropropylene (HFP) copolymer (FEP), a TFE/perfluoro(alkyl vinyl ether) (PAVE) copolymer (PFA), an ethylene/TFE copolymer (ETFE), a TFE/HFP/PAVE copolymer, a TFE/HFP/vinylidene fluoride copolymer (THV), a TFE/ethylene/perfluorodimethyldioxole copolymer, a TFE/CF₂═CFOCF₂CF(CF₃)OCF₂CF₂SO₂F copolymer, or a mixture of any of these copolymers; and
(4) the fluorine-containing extractant is decafluoropentane.

The present invention also provides a method for producing the above resin pellets, the method including cleaning the resin pellets containing at least one selected from tetrafluoroethylene homopolymers or copolymers with a fluorine-containing cleaning agent.

A preferred embodiment of the method for producing the resin pellets of the present invention is as follows:
(1) the fluorine-containing cleaning agent is at least one selected from hydrofluorocarbons, perfluorocarbons, and fluorine-containing ethers; and
(2) the cleaning with the fluorine-containing cleaning agent is followed by cleaning with an acid or alkaline solution.

The present invention further provides a molded product made from the above resin pellets.

A preferred embodiment of the molded product of the present invention is as follows:
(1) the evaporation residue after evaporating and drying the extract obtained by dissolving and extracting the fluorine-containing substance contained in or adhering to the molded product in a fluorine-containing extractant is 20×10⁻⁶ mg/mm² or less;
(2) the molded product has a hollow portion;
(3) the molded product is cleaned with a fluorine-containing cleaning agent, particularly at least one fluorine-containing cleaning agent selected from hydrofluorocarbons, perfluorocarbons, and fluorine-containing ethers; and
(4) after the molded product has been cleaned with the fluorine-containing cleaning agent, the molded product is cleaned with an acid or alkaline solution.

### Effect of the Invention

The present invention provides resin pellets that are suitable for molding a molded product used in a semiconductor manufacturing apparatus, and inherently has high cleanliness. Since the resin pellets have a melt flow rate (MFR) equivalent to that of the resin pellets before cleaning, it can be used without changing the molding conditions of the molded product.

The present invention provides a fluororesin molded product including the resin pellets used in a semiconductor manufacturing apparatus, and inherently has high cleanliness.

The present invention provides a molded product that inherently has high cleanliness and is used in a semiconductor manufacturing apparatus, such as a molded product for liquid transfer or liquid contact, and thus allows to produce a circuit pattern of a semiconductor device while suppressing the occurrence of defects by a semiconductor manufacturing apparatus including the molded product.

### DESCRIPTION OF THE PREFERRED EMBODIMENTS

### Resin Pellet

The resin pellet of the present invention includes at least one selected from tetrafluoroethylene (TFE) homopolymers or copolymers, is essentially characterized in that the evaporation residue after evaporating and drying the extract obtained by dissolving and extracting the fluorine-containing substance contained in or adhering to the resin pellets in the fluorine-containing extract is 20×10⁻⁶ mg/mm² or less, and has a high degree of cleanliness capable of suitably molding a molded product used in a semiconductor manufacturing apparatus.

### Fluorine-Containing Substance

The fluorine-containing substance contained in or adhered to the resin pellets of the present invention comprises carbon and fluorine, and is a gaseous decomposition product containing fluorine produced by thermal decomposition of unstable terminal groups in the homopolymer of tetrafluoroethylene and the copolymer of TFE, which is solidified by lowering the temperature. The fluorine-containing substance is contained in or adhered to the resin pellets in a very small amount.

The fluorine-containing substance has a very small amount of adhesion per unit area, has a property of exhibiting high resistance to a hydrocarbon organic solvent and being difficult to dissolve therein. Therefore, it is a compound that is not detected by gas chromatography-mass spectrometry (GC/MS) and difficult to quantitatively analyze. In addition, it is a non-polar to medium-polar compound, which has a low molecular weight, starts decomposition at about 150° C., and vaporizes at about 300° C. or lower.

The fluorine-containing substance is not preferable because they adhere to the wafer surface in the semiconductor manufacturing process and become nano-sized particles (contaminant fine particles) that cause defects in the circuit pattern of fine semiconductor devices. However, in the resin pellets of the present invention, the evaporation residue described above is as close to zero as possible and reduced to 20×10⁻⁶ mg/mm² or less, indicating that the fluorine-containing substance is significantly reduced.

### Evaporation Residue

In the resin pellets of the present invention, the evaporation residue after evaporating and drying the extract obtained by extracting the fluorine-containing substance contained in or adhering to the resin pellets in a fluorine-containing extractant is as close to zero as possible, and desirably 20×10⁻⁶ mg/mm² or less, preferably in the range of from 0 to 10×10⁻⁶ mg/mm², and more preferably in the range of from 0 to 1.0×10⁻⁶ mg/mm². In the resin pellets having the evaporation residue is in this range, a causative substance (a fluorine-containing substance) that adheres to the wafer surface in the semiconductor manufacturing process and causes the generation of nano-sized particles with a particle size of 300 nm or less, especially 50 nm or less, which causes defects in the circuit pattern of fine semiconductor devices, is reduced.

Therefore, the molded product including the resin pellets of the present invention as a molding material is, as a result, a fluororesin molded product in which the generation of nano-sized particles (contaminant fine particles) is suppressed.

The causative substance that causes the generation of nano-sized particles of 50 nm or less includes metal ions or metal fine particles in addition to the fluorine-containing substance. Since metal ions easily bind to fluorine ions, metal ions or metal fine particles may become nuclei and form aggregates of the fluorine-containing substance. In the present invention, it is possible to reduce aggregates of the fluorine-containing substance containing such metal ions or metal fine particles.

Metal ions or metal fine particles covered with aggregates of the fluorine-containing substance (bonded metal ions or metal fine particles contained in the fluorine-containing substance) reduce the dissolution/cleaning effect of acids and alkalis. However, cleaning with the below-described fluorine-containing cleaning agent of the present invention removes the fluorine-containing substance that protects the metal ions or metal fine particles, and thus enhances the dissolution/cleaning effect of acids and alkalis on the metal ions or metal fine particles.

That is, cleaning with an acid or alkali as a post-treatment for cleaning with the fluorine-containing cleaning agent according to the present invention reduces the fluorine-containing substance and aggregates of fluorine-containing substance, and allows to obtain the resin pellets with reduced metal ions or metal particles and a fluororesin molded product including the pellets in which both fluorine-containing substance and metal ions or metal fine particles are reduced.

In the present invention, the fluorine-containing extractant used for dissolving and extracting the fluorine-containing substance contained in or adhered to the resin pellets may be selected from various fluorine-containing solvents as long as the fluorine-containing substance contained in or adhered to the resin pellets can be dissolved. Examples of such a fluorine-containing extractant include at least one fluorine-containing extractant selected from hydrofluorocarbons, perfluorocarbons, fluorine-containing ethers, and others. The fluorine-containing extractant used for measuring the evaporation residue preferably does not leave impurity components (components intentionally added) contained in the fluorine-containing extractant in the evaporation residue. Even if the solvent dissolves the fluorine-containing substance, if the impurity component contained in the fluorine-containing extractant remains as an evaporation residue, for example, in the case of propylene glycol methyl ether acetate (PGMEA), it is not preferable because the impurity component (antioxidant) added to PGMEA remains as an evaporation residue.

From the perspective of the purity of the evaporation residue described above, the fluorine-containing extractant used for measuring the evaporation residue on the resin pellets of the present invention is preferably a decafluoropentane such as 1,1,1,2,3,4,4,5,5,5-decafluoropentane, 1,1,1,2,3,3,4,5,5,5-decafluoropentane, 1,1,1,2,3,3,4,4,5,5-decafluoropentane, 1,1,2,3,3,4,4,5,5,5-decafluoropentane, 1,1,2,2,3,4,4,5,5,5-decafluoropentane, 1,1,2,2,3,3,4,4,5,5-decafluoropentane, 1,2,2,3,3,4,4,5,5,5-decafluoropentane, 1,1,1,3,3,4,4,5,5,5-decafluoropentane, or 1,1,1,2,2,4,4,5,5,5-decafluoropentane, and more preferably 1,1,1,2,3,4,4,5,5,5-decafluoropentane.

The fluorine-containing extractant may be appropriately selected depending on the type of fluorine-containing substance to be dissolved, and preferably does not dissolve the resin pellets themselves. The fluorine-containing extractant preferably has a large boiling point difference from the fluorine-containing substance, and the boiling point difference is preferably 10° C. or more. That is, as described above, the fluorine-containing substance contained in or adhered to the resin pellets starts decomposition at about 150° C., so that decomposition of the fluorine-containing substance starts when the boiling point of the fluorine-containing extractant is close to 150° C., this reduces the evaporation residue on the fluorine-containing substance and makes quantitative analysis difficult. Specifically, the fluorine-containing extractant is preferably gaseous or liquid at room temperature (20 to 30° C.) and preferably has a boiling point that does not destroy the molecular structure of the fluorine-containing substances, and the boiling point is from 0 to 120° C., preferably from 0 to 70° C., and more preferably 20 to 70° C. In addition, from the perspective of handleability, the boiling point is preferably at least 20° C. higher than room temperature (20 to 30° C.).

When measuring the evaporation residue, it is preferable to immerse the resin pellets in the fluorine-containing extractant so that the mixing ratio of the resin pellets and the fluorine-containing extractant (fluorine-containing extractant/resin pellets) is from 2.0 to 2.5 in terms of weight ratio.

With the resin pellets immersed in the fluorine-containing extractant, the resin pellets are allowed to stand at a temperature of 60±2° C. for 20 hours, and then the resin pellets are separated from the fluorine-containing extractant (extract) from which the fluorine-containing substance is extracted, and the extract is evaporated and dried. It is preferable to use an evaporator for evaporation and drying, and it is preferable to use an electronic balance for quantification of evaporation residue.

The particle size and the number of nano-sized particles (foreign particles) can be measured by, for example, a particle counter (submerged particle counter), a wafer surface inspection apparatus, or a total reflection X-ray fluorescence (TXRF).

The evaporation residue on the resin pellets of the present invention can be quantified because a very small amount of the fluorine-containing substance is concentrated through the steps of evaporation and drying. As a result, it becomes possible to judge the presence or absence of inclusion or adhesion of the fluorine-containing substance, which adheres to the wafer surface in the semiconductor manufacturing process and becomes a causative substance that forms nano-sized particles (contaminant fine particles) that cause defects in the circuit pattern of fine semiconductor devices, to the resin pellets, and it becomes possible to predict the residual amount of fluorine-containing substance on the wafer.

### Pellet Form

The resin pellets of the present invention include a resin containing at least one selected from tetrafluoroethylene homopolymers and copolymers, and is used as a molding material in which the resin is processed into granules (pellets) to improve handleability.

The average particle size of the resin pellets is not limited to this, but is preferably from 0.4 to 5.0 mm. Examples of the resin pellets in the above average particle size range include pellets having an average particle size of from 0.4 to less than 1 mm called mini pellets and pellets having an average particle size of from 1.0 to 5.0 mm. Pellets having a suitable average particle size may be appropriately used as a molding material depending on the intended use.

### TFE Homopolymer

The tetrafluoroethylene homopolymer constituting the resin pellets of the present invention may be PTFE, which is a homopolymer of tetrafluoroethylene (TFE), modified PTFE, which does not have melt flowability and is modified with at least one monomer copolymerizable with tetrafluoroethylene (TFE) within the range that does not impair the characteristics of PTFE, or a mixture of PTFE and at least one modified PTFE. Examples of the monomer of the modified PTFE include ethene, propene, isobutylene, chloroethene, dichloroethene, fluoroethene, difluoroethene, perfluorobutylethylene (3,3,4,4,5,5,5,6,6,6-nonafluoro-1-hexene), chlorotrifluoroethene, perfluoroalkene with 3 or more carbon atoms, and perfluoro(alkyl vinyl ether).

Examples of the modified PTFE which are copolymers of TFE and a small amount of monomers other than TFE are described in WO 2007/119829, and specific examples thereof include a copolymer of tetrafluoroethylene and 0.005 to 1 mol %, preferably 0.01 to 0.1 mol %, and more preferably 0.01 to 0.05 mol % of at least one monomer selected from hexafluoropropylene, perfluoro(alkylvinyl ether), fluoroalkyl ethylene, chlorotrifluoroethylene, vinylidene fluoride, vinyl fluoride, and ethylene, the copolymer having no melt moldability. Of these, fluorine-containing monomers are preferable, and perfluoroalkene having 3 to 6 carbon atoms and perfluoro(alkyl vinyl ether) having an alkyl group with 1 to 6 carbon atoms are more preferable.

The tetrafluoroethylene homopolymer can be produced by a known method such as solution polymerization, emulsion polymerization, suspension polymerization and the like.

### TFE Copolymer

The tetrafluoroethylene copolymer constituting the resin pellets of the present invention is a copolymer of tetrafluoroethylene (TFE) and 1 mol % or more of a monomer copolymerizable with tetrafluoroethylene (TFE). The tetrafluoroethylene copolymer is a copolymer that melts at a temperature equal to or higher than the melting point and exhibits melt flowability (heat meltability), or a composition including the copolymer, and examples thereof include copolymers of unsaturated fluorinated hydrocarbons, unsaturated fluorinated chlorinated hydrocarbons, and ether group-containing unsaturated fluorinated hydrocarbons, and heat-meltable fluororesins such as copolymers of these unsaturated fluorinated hydrocarbons and ethylene.

Examples thereof include copolymers including tetrafluoroethylene and 1 to 60 mol % or less of at least one comonomer, such as a copolymer with at least one monomer selected from perfluoroalkene having 3 or more carbon atoms and fluoroalkoxytrifluoroethylene (preferably perfluoro(alkyl vinyl ether)) (PAVE) (alkyl group is a linear or branched alkyl group having 1 to 5 carbon atoms)), or a copolymer of any of these monomers and ethylene.

Examples of preferred copolymers include a TFE/hexafluoropropylene (HFP) copolymer (FEP), a TFE/perfluoro(alkyl vinyl ether) (PAVE) copolymer (PFA), an ethylene/TFE copolymer (ETFE), a TFE/HFP/PAVE copolymer, a TFE/HFP/vinylidene fluoride copolymer (THV), a TFE/ethylene/perfluorodimethyldioxol copolymer, a TFE/CF₂═CFOCF₂CF(CF₃)OCF₂CF₂SO₂F copolymer, and mixture of these copolymers. More preferable examples include at least one copolymer selected from TFE/perfluoro(methyl vinyl ether) (PMVE) copolymer, a TFE/perfluoro(ethyl vinyl ether) (PEVE) copolymer, a TFE/perfluoro(propyl vinyl ether) (PPVE) copolymer, a TFE/perfluoro(butenyl vinyl ether) copolymer.

The amount of PAVE in the copolymer is preferably from 1 to 30 mol % and more preferably from 1 to 20 mol %. In addition, the amount of hexafluoropropylene in FEP is preferably from 1 to 10 mol %.

Further, in order to suppress the generation of pyrolysate, a copolymer with minimal elution of impurities prepared by converting (fluorinating) unstable terminal groups such as —CF₂CH₂OH, —CONH₂, or —COF to thermally stable —CF₃ terminal groups may be used.

The tetrafluoroethylene copolymer is preferably a copolymer having a melt flow rate (MFR) of about 1 to 100 g/10 minutes at 372° C. according to ASTM D-1238. The melt flow rate (MFR) can be selected in accordance with the molding method. For example, in melt molding such as melt extrusion molding or injection molding, the melt flow rate is from 1 to 100 g/10 min, preferably from 1 to 50 g/10 min, and more preferably from 1 to 20 g/10 min.

The tetrafluoroethylene copolymer may be used alone or a mixture of two or more of these copolymers. Other examples include mixtures of at least two or more copolymers of the same type being different in, for example, the monomer type, monomer content, molecular weight (weight average molecular weight or number average molecular weight), molecular weight distribution, melting point, and melt flow rate (MFR), or mechanical properties. Examples thereof include PFA mixtures and FEP mixtures.

The tetrafluoroethylene copolymer can be produced by a known method such as solution polymerization, emulsion polymerization, or suspension polymerization.

The melting point of the tetrafluoroethylene copolymer is not limited, but is preferably 150° C. or higher, and preferably from 150° C. to 340° C.

The resin containing at least one selected from tetrafluoroethylene homopolymers and copolymers of the present invention may be a mixture of the above-described tetrafluoroethylene polymer having no melt moldability and a tetrafluoroethylene copolymer having melt moldability.

### Method for Producing Resin Pellets

The resin pellets of the present invention can be produced by molding at least one resin selected from the above-mentioned tetrafluoroethylene homopolymers and copolymers into granules (pellets) and then cleaning with a fluorine-containing cleaning agent.

The molding method for obtaining the resin pellets is not particularly limited, and a known method may be used. For example, the pellets can be obtained by melt-kneading and extruding using a single-screw extruder, a twin-screw extruder, or a tandem extruder, and cutting to a predetermined length by a melt-cut method or a strand method.

The average particle size of the resin pellets is preferably in the range of from 0.4 to 5.0 mm as described above.

In the resin pellets of the present invention, by cleaning the obtained resin pellets with a fluorine-containing cleaning agent, the fluorine-containing substance contained in or adhered to the resin pellets can be reduced to make the above-described evaporation residue as close to zero as possible.

The resin pellets are cleaned by bringing the fluorine-containing cleaning agent described below into contact with the resin pellets. Examples of the method include a method of immersing (and stirring) resin pellets in a fluorine-containing cleaning agent, and a method of flowing the fluorine-containing cleaning agent on the surface of the resin pellets (circulating the fluorine-containing cleaning agent of the present invention using a pump or the like)

From an economical point of view, the cleaning treatment is preferably performed at a temperature from room temperature to a temperature at which the saturated vapor pressure is about 70 kPa, or a temperature about 10° C. lower than the boiling point of the fluorine-containing solvent used.

The mixing ratio of the fluorine-containing cleaning agent and the resin pellets used in the cleaning treatment (fluorine-containing cleaning agent/resin pellets (weight ratio)) is not limited, but is preferably 0.01 or more, and more preferably 0.1 or more.

The fluorine-containing cleaning agent used for cleaning the resin pellets is a solvent for dissolving a causative substance (fluorine-containing substance) that causes nano-sized particles contained in or adhered to the resin pellet, and includes a fluorine-containing solvent. The fluorine-containing cleaning agent is preferably at least one selected from hydrofluorocarbons, perfluorocarbons, and fluorine-containing ethers.

A hydrofluorocarbon is a saturated or unsaturated compound containing only carbon, fluorine, and hydrogen atoms and having a carbon number of from 3 to 9 and preferably from 4 to 8, wherein at least 50% of all atoms bonded to carbon atoms are fluorine atoms. Examples thereof include saturated hydrocarbons such as tridecafluorooctane, pentadecafluoroheptane, decafluoropentane, pentafluorobutane, pentafluoropropane, and heptafluorocyclopentane, and unsaturated hydrocarbons such as hydrofluoroolefin (HFO) represented by the following general formula (I): R_{f}—CH₂CH═CHCH₂—R_{f}(I) (wherein R_{f} is a perfluoroalkyl group).

Decafluoropentane represented by C₅H₂F₁₀ is preferably used as a saturated hydrocarbon. There are many structural isomers of decafluoropentane, but a mixture thereof may be used. More preferable is 1,1,1,2,3,4,4,5,5,5-decafluoropentane or a mixture of 1,1,1,2,3,4,4,5,5,5-decafluoropentane and another decafluoropentane isomer.

The unsaturated hydrocarbon is preferably 2,3,3,3-tetrafluoro-1-propene (HFO-1234yf), an isomer thereof, 1,1,1,4,4,4-hexafluoro-2-butene, an isomer thereof, or a mixture of the isomers. The 1,1,1,4,4,4-hexafluoro-2-butene is more preferably (Z)-HFO-1336 mzzm.

A perfluorocarbon is a saturated or unsaturated compound containing only carbon and fluorine atoms and having a carbon number of from 1 to 9, and examples thereof include completely fluorinated cycloalkanes such as tetrafluoromethane, hexafluoroethane, octafluoropropane, decafluorobutane, dodecafluoropentane, tetradecafluorohexane, octafluorocyclobutane, and perfluoromethylcyclohexane, and unsaturated hydrocarbons such as perfluoroolefin represented by the following general formula (II): CF₂═CFR_{f} . . . (II) (wherein R_{f} is a perfluoroalkyl group).

There are several isomers of perfluoroheptene such as perfluoro-2-heptene and perfluoro-3-heptene, and these may be used alone or in combination.

A fluorine-containing ether is an ether containing fluorine, and examples thereof include hydrofluoroether (HFE) and perfluoroether (PFE).

Examples of hydrofluoroethers (HFE) include saturated or unsaturated compounds having ether bonds, and examples thereof include hexafluoroisopropanol, trifluoroethanol, tetrafluoroethanol, pentafluoropropanol, 1,1,1-trifluoroethyl-1,1,2,2-tetrafluoroethyl ether, nonafluorobutylmethyl ether, and alkoxyperfluoroalkene. Preferable is a hydrofluoroether having 3 to 8 carbon atoms, and examples thereof include Novec™ 7200, Novec™ 7500, and Novec™ 7600 manufactured by 3M Japan Ltd.

Examples of pefluoroether (PFE) include perfluoro(alkyl)alkyl ethers such as perfluoro(propyl)methyl ether, perfluoro(butyl)methyl ether, perfluoro(hexyl)methyl ether, and perfluoro(butyl)ethyl ether.

Examples of alkoxyperfluoroalkenes include methoxyperfluoroalkenes and ethoxyperfluoroalkenes having a carbon number of from 5 to 10, and preferable examples include methoxyperfluoropentene, methoxyperfluorohexene, methoxyperfluoroheptene, methoxyperfluorooctene, ethoxyperfluoropentene, ethoxyperfluorohexene, ethoxyperfluoroheptene, ethoxyperfluorooctene, and mixtures thereof. Note that there are multiple structural isomers of alkoxyperfluoroalkenes, but the structure thereof is not particularly limited. Mixtures thereof may be used, and a structure suited to the object of the present invention can be selected appropriately.

More preferable examples include methoxyperfluoroheptene, isomers thereof, and mixtures thereof. The following are examples of the structure of methoxyperfluoroheptene, but any of the structures may be used.

CF₃(CF₂)₂CF═CFCF(OCH₃)CF₃ (1)

CF₃CF₂CF═CF(CF₂)₂(OCH₃)CF₃ (2)

CF₃CF₂CF═CFCF(OCH₃)CF₂CF₃ (3)

CF₃CF═CFCF(OCH₃)(CF₂)₂CF₃ (4)

CF₃CF═CFCF₂CF(OCH₃)CF₂CF₃ (5)

CF₃CF₂CF═C(OCH₃)(CF₂)₂CF₃ (6)

CF₃CF₂C(OCH₃)═CFCF₂CF₂CF₃ (7)

Examples of preferable methoxyperfluoroheptene include Opteon™ SF10 manufactured by Chemours-Mitsui Fluoroproducts Co., Ltd.

The fluorine-containing extraction cleaning agent can also be appropriately selected depending on the type of the fluorine-containing substance to be dissolved, similarly to the fluorine-containing extractant described above. The boiling point difference from the fluorine-containing substance is preferably large, and the boiling point difference is more preferably 10° C. or more. That is, as described above, the fluorine-containing substance contained in or adhered to the resin pellet starts to be decomposed at about 150° C., so that decomposition of the fluorine-containing substance starts when the boiling point of the fluorine-containing extractant is close to 150° C., the evaporation residue of the fluorine-containing substance decreases, and quantitative analysis becomes difficult. Specifically, the fluorine-containing cleaning extractant is preferably gaseous or liquid at room temperature (20 to 30° C.) and preferably has a boiling point that does not destroy the molecular structure of the fluorine-containing substance, and the boiling point is from 0 to 120° C., preferably from 0 to 70° C., and more preferably from 20 to 70° C. In addition, from the perspective of handleability, the boiling point is preferably at least 20° C. higher than room temperature (20 to 30° C.).

In addition, the fluorine-containing cleaning agent used to clean the resin pellets preferably leaves no impurity component (component added intentionally) of the fluorine-containing cleaning agent on the resin pellets. The cleaning agent is preferably, similar to the fluorine-containing extractant used for measuring the evaporation residue described above, decafluoropentane such as 1,1,1,2,3,4,4,5,5,5-decafluoropentane, 1,1,1,2,3,3,4,5,5,5-decafluoropentane, 1,1,1,2,3,3,4,4,5,5-decafluoropentane, 1,1,2,3,3,4,4,5,5,5-decafluoropentane, 1,1, 2,2,3,4,4,5,5,5-decafluoropentane, 1,1,2,2,3,3,4,4,5,5-decafluoropentane, 1,2,2 3,3,4,4,5,5,5-decafluoropentane, 1,1,1,3,3,4,4,5,5,5-decafluoropentane, or 1,1,1,2,2,4,4,5,5,5-decafluoropentane, and more preferably 1,1,1,2,3,4,4,5,5,5-decafluoropentane.

The resin pellets cleaned with the fluorine-containing cleaning agent are separated from the fluorine-containing cleaning agent, dried at a temperature of 270±5° C. for 20 hours, and then cooled in a furnace to obtain the resin pellets of the present invention. Since the melt flow rate of the cleaned resin pellets is the same as the melt flow rate of the resin pellets before cleaning, they can be used without changing the molding conditions of the molded product.

In the present invention, as the post-treatment for cleaning with the above-described fluorine-containing cleaning agent, as described above, cleaning with an acid or alkali may be added. This makes it possible to obtain resin pellets in which not only the fluorine-containing substance and aggregates of the fluorine-containing substance are reduced, but also metal ions or metal fine particles are reduced.

### Molded Product

The molded product of the present invention is a molded product including the resin pellets of the present invention described above, and preferably a molded product in which the evaporation residue after evaporating and drying the extract obtained by dissolving and extracting the fluorine-containing substance contained in or adhered to the molded product in the fluorine-containing extractant is 20×10⁻⁶ mg/mm² or less.

The evaporation residue is preferably as close to zero as possible even in the molded product, and is preferably in the range of from 20×10⁻⁶ mg/mm² or less, preferably in the range of from 0 to 10×10⁻⁶ mg/mm², and more preferably in a range of from 0 to 1.0×10⁻⁶ mg/mm². In the molded product of the present invention in which the evaporation residue is in this range, the generation of the causative substance (fluorine-containing substance) that causes the generation of the particles is suppressed, so that the molded product is suitable as a molded product having high cleanliness used in semiconductor manufacturing.

The measurement of the evaporation residue of the fluorine-containing substance contained in or adhered to the molded product can be performed in the same manner as the resin pellets described above, however, it is preferable to bring the surface of the molded product into contact with the fluorine-containing extractant depending on the shape of the molded product. For example, in a molded product having a hollow portion such as a tube or a bottle, an extract can be collected by enclosing a fluorine-containing extractant inside the tube or the bottle.

The molded product of the present invention is preferably a molded product used for liquid transfer, liquid contact, and the like. Specifically, a molded product for liquid transfer is that used in liquid transfer devices such as tubes, pipes, fittings for pipes, gaskets, O-rings, pumps, valves, regulators, and filter housings, and a molded product for liquid contact is that used in tools and apparatuses that come into contact with liquids other than those for liquid transfer, for example, containers such as transport containers and storage containers (for example, bottles, caps, and inner lids), wafer carriers, and films.

The molded product of the present invention is preferably a molded product having a hollow portion. Examples of the molded product having such a hollow portion include bottles, tubes, pipes, and fittings for piping.

The method for molding the molded product of the present invention is not particularly limited, and the molded product of the present invention may be molded by a known molding method using the resin pellets of the present invention. Examples of the molding method include compression molding, paste extrusion molding, melt compression molding, melt extrusion molding, injection molding, transfer molding, blow molding, rotary molding, lining molding, and film molding.

Since the molded product of the present invention is molded using the resin pellets of the present invention, the above-described evaporation residue is reduced to 20×10⁻⁶ mg/mm² or less, however, the molded product may be further subjected to a cleaning treatment using the above-described fluorine-containing cleaning agent. This further improves the cleanliness of the molded product.

Examples of the cleaning treatment include, similarly to the resin pellet cleaning process described above, a method of contacting, dipping (and stirring), and shaking a fluorine-containing cleaning agent with a molded product, and a method of flowing a fluorine-containing cleaning agent on the surface of a molded product (circulating the fluorine-containing cleaning agent using a pump or the like).

The conditions of the cleaning treatment may be the same as the cleaning treatment of the resin pellets described above.

Further, cleaning with an acid or alkali as a post-treatment for cleaning with the fluorine-containing cleaning agent according to the present invention reduces the fluorine-containing substance protecting metal ions or metal particles, and allows to obtain resin pellets with reduced metal ions or metal particles and a fluororesin molded product including the pellets in which both fluorine-containing substance and metal ions or metal particles are reduced.

When the fluorine-containing cleaning agent used in the present invention can dissolve and extract deposits or inclusions in the resin pellets or molded product, the cleaning agent may be used for resin pellets made of engineering plastics such as resin pellets made of polyethylene, polypropylene, vinyl chloride, phenol resin, or silicone resin, and molded products including these pellets, other than the above-described resin pellets made of at least one selected from tetrafluoroethylene homopolymers or copolymers, or molded products including these resin pellets.

### EXAMPLES

The present invention will be described in further detail hereinafter using examples, however, the present invention is not limited to these examples.

The materials, cleaning treatments, and measurement methods used in the examples are as follows.

### Materials

### 1. Resin Pellet

(1) PFA pellet (1)
(MFR: 2 g/10 min, melting point 310° C.)
(2) PFA pellet (2)
(MFR: 5 g/10 min, melting point 263° C.)

### 2. Fluorine-Containing Extractant

(1) 1,1,1,2,3,4,4,5,5,5-decafluoropentane (boiling point 55° C.) (indicated by “XF” in the table)

### 3. Fluorine-Containing Cleaning Agent

(1) Methoxyperfluoroheptene (boiling point 110° C.) (indicated by “SF10” in the table)
(2) Perfluoroheptene (boiling point 72° C.) (indicated by “PFH” in the table)
(3) 1,1,1,2,3,4,4,5,5,5-decafluoropentane (boiling point 55° C.) (indicated by “XF” in the table)

### 4. Molded Product Including Resin Pellets

(1) Tube
Using the resin pellets shown in Table 1, the resin pellets were heated to a temperature equal to or higher than the melting point and extruded to obtain an unstretched tube having an outer diameter of 6.35 mm, an inner diameter of 4.35 mm and a length of 50 m.
(2) Bottle
Using the resin pellets shown in Table 1, the resin pellets were heated a temperature equal to or higher than the melting point to obtain a 100 ml bottle by blow molding.

### 5. Cleaning Treatment

(1) Cleaning treatment of resin pellets
The mixture of the fluorine-containing cleaning agent and the resin pellets, which were mixed at the weight ratio (fluorine-containing cleaning agent/resin pellets) shown in Table 1 or Table 3, was heated in an oven at the cleaning temperature shown in Table 1 or Table 3 for 2 hours, and then the resin pellets and the fluorine-containing cleaning agent were separated. The separated resin pellets were dried at the drying temperatures shown in Table 1 or Table 3 for 20 hours, and then cooled in a furnace until the temperature reached room temperature (20 to 30° C.).
(2) Cleaning treatment of molded product (tube)
The fluorine-containing cleaning agent shown in Table 2 was sealed in the 50 m unstretched tube by folding both ends by 100 mm using a plastic band, and allowed to stand in an oven at 60° C. for 20 hours. Thereafter, the tube was dried at room temperature (20 to 30° C.) for 5 to 10 minutes using nitrogen gas passed through a 0.003 μM in-line filter.
(3) Cleaning treatment of molded product (bottle)
130 g of the fluorine-containing cleaning agent shown in Table 2 was sealed in the 100 ml bottle using a cleaned PFA lid, and allowed to stand at room temperature for 168 hours. Thereafter, the fluorine-containing cleaning agent was discharged, and the bottle was dried at room temperature (20 to 30° C.) for 24 hours or more in a clean room having a cleanliness class of 100 or less.

### Measurement Method

### 6. Measurement of Evaporation Residue

(1) Evaporation residue (blank) of 1,1,1,2,3,4,4,5,5,5-decafluoropentane (XF)
In a round-bottom flask (300 ml), 500 g or 130 g of 1,1,1,2,3,4,4,5,5,5-decafluoropentane (XF) was placed, and each was evaporated and dried (evaporated to dryness) using an evaporator. Each evaporation residue was weighed using an electronic balance, and the amount of evaporation residue (mg) of 1,1,1,2,3,4,4,5,5,5-decafluoropentane was determined.
(2) Evaporation residue on resin pellets
The resin pellets were immersed in 1,1,1,2,3,4,4,5,5,5-decafluoropentane (XF) and allowed to stand at 60° C. for 20 hours. Then, 1,1,1,2,3,4,4,5,5,5-decafluoropentane (XF) was filtered using a polypropylene filtration membrane having a membrane diameter of 0.2 μm to remove the PFA fine powder contained in or adhered to the resin pellets, and the filtrate was used as an extract. 500 g of the extract was evaporated and dried using an evaporator, and the evaporation residue was weighed using an electronic balance. From that amount, the amount of evaporation residue in 500 g of 1,1,1,2,3,4,4,5,5,5-decafluoropentane in (1) above was subtracted to obtain the evaporation residue per pellet unit surface area (mg/mm²). The surface area of the pellet was calculated according to SEMI C90-1015.
(3) Evaporated residue on molded product (unstretched tube)
1,1,1,2,3,4,4,5,5,5-decafluoropentane (XF) was sealed into 50 m of the above-described molded product (unstretched tube) by folding both ends of the tube by 100 mm and using a plastic band, allowed to stand at 60° C. for 20 hours, and was extracted using nitrogen gas to prepare an extract. 500 g of the extract was evaporated and dried using an evaporator, and the evaporation residue was weighed using an electronic balance. From that amount, the amount of evaporation residue in 500 g of 1,1,1,2,3,4,4,5,5,5-decafluoropentane in (1) above was subtracted to obtain the evaporation residue per inner surface area of the unstretched tube (mg/mm²).
(4) Evaporation residue on molded product (bottle)
130 g of 1,1,1,2,3,4,4,5,5,5-decafluoropentane (XF) was sealed in the bottle (100 ml), allowed to stand at room temperature for 168 hours, and then used as an extract. 130 g of the extract was evaporated and dried using an evaporator, and the evaporation residue was weighed using an electronic balance. From that amount, the amount of evaporation residue in 130 g of 1,1,1,2,3,4,4,5,5,5-decafluoropentane in (1) above was subtracted to obtain the evaporation residue per inner surface area of the bottle (mg/mm²).

### 7. Melt Flow Rate (MFR)

Using a melt indexer (manufactured by Toyo Seiki Seisaku-sho, Ltd.) equipped with anticorrosive cylinders, dies, and pistons that comply with ASTM D-1238-95, 5 g of sample powder was filled in a cylinder held at 372±1° C., held for 5 minutes, and then extruded through a die orifice under a load of 5 kg (piston and weight). The extrusion amount (g/10 minutes) at this time was determined as MFR.

### Examples 1 to 6

After performing a cleaning treatment using the resin pellets and conditions shown in Table 1, the evaporation residue on the resin pellets was determined. The results are shown in Table 1.

### Comparative Example 1

The evaporation residue of the resin pellets shown in Table 1 was determined in the same manner as in Example 1 except that the cleaning treatment was not performed. The results are shown in Table 1.

### Examples 7 to 10

The evaporation residue on the molded product (tube) including the resin pellets of Examples 1, 3, 4, and 6 shown in Table 2 was determined. The results are shown in Table 2.

### Examples 11 to 14

After cleaning the molded product (tube) including the resin pellets of Examples 1, 3, 4, and 6 shown in Table 2, the evaporation residue on the molded product (tube) was determined. The results are shown in Table 2.

### Example 15

After cleaning the molded product (bottle) including the resin pellets of Example 3 shown in Table 2, the evaporation residue on the molded product (bottle) was determined. The results are shown in Table 2.

### Comparative Example 2

The evaporation residue on the molded product (tube) including the pellets of Comparative Example 1 was determined in the same manner as in Example 7 except that the resin pellets of Comparative Example 1 were used. The results are shown in Table 2.

### Comparative Example 3

The evaporation residue on the molded product (tube) including the pellets of Comparative Example 1 was determined in the same manner as in Example 11 except that the resin pellets of Comparative Example 1 were used. The results are shown in Table 2.

### Comparative Example 4

The evaporation residue on the molded product (bottle) including the pellets of Comparative Example 1 was determined. The results are shown in Table 2.

### Comparative Example 5

The evaporation residue on the molded product (bottle) including the pellets of Comparative Example 1 was determined in the same manner as in Example 15 except that the resin pellets of Comparative Example 1 were used. The results are shown in Table 2.

### Examples 16 to 17

After performing a cleaning treatment using the resin pellets and conditions shown in Table 3, the evaporation residue on the resin pellets was determined. The results are shown in Table 3.

### Comparative Example 6

The evaporation residue on the resin pellets was determined in the same manner as in Example 16 except that the cleaning treatment was not performed. The results are shown in Table 3.

TABLE 1

| | | Cleaning conditions for resin pellets | | | | Evaporation |
|---|---|---|---|---|---|---|
| | | | | Cleaning | | residue |
| | | | | agent/ | | (residue/ |
| | | | Cleaning | pellet | Drying | surface |
| | Resin | Cleaning | temperature | (weight | temperature | area) |
| | pellet | Agent | (° C.) | ratio) | (° C.) | mg/mm² |
| Example 1 | PFA (1) | SF10 | 110 | 0.2 | 270 | 75 × 10⁻⁸ |
| Example 2 | PFA (1) | SF10 | Room temperature | 0.5 | 270 | 38 × 10⁻⁸ |
| Example 3 | PFA (1) | SF10 | 110 | 0.5 | 270 | 11 × 10⁻⁸ |
| Example 4 | PFA (1) | SF10 | 110 | 0.5 | 150 | 33 × 10⁻⁸ |
| Example 5 | PFA (1) | PFH | 70 | 0.2 | 270 | 29 × 10⁻⁸ |
| Example 6 | PFA (1) | PFH | 70 | 0.5 | 270 | 10 × 10⁻⁸ |
| Comparative | PFA (1) | — | — | — | — | 395 × 10⁻⁸ |
| Example 1 | | | | | | |

TABLE 2

| | | | | | Amount of |
|---|---|---|---|---|---|
| | | | | | evaporation |
| | | Cleaning conditions for molded product | | | residue |
| | | | With or | | Evaporation |
| | Resin | Molded | without | Cleaning | residue/surface |
| | pellet | product | cleaning | agent | area mg/mm² |
| Example 7 | Example 1 | Tube | Not cleaned | — | 35 × 10⁻⁸ |
| Example 8 | Example 3 | Tube | Not cleaned | — | 0 × 10⁻⁸ |
| Example 9 | Example 4 | Tube | Not cleaned | — | 0 × 10⁻⁸ |
| Example 10 | Example 6 | Tube | Not cleaned | — | 0 × 10⁻⁸ |
| Example 11 | Example 1 | Tube | Cleaned | XF | 14 × 10⁻⁸ |
| Example 12 | Example 3 | Tube | Cleaned | XF | 0 × 10⁻⁸ |
| Example 13 | Example 4 | Tube | Cleaned | XF | 0 × 10⁻⁸ |
| Example 14 | Example 6 | Tube | Cleaned | XF | 0 × 10⁻⁸ |
| Example 15 | Example 3 | Bottle | Cleaned | SF10 | 20 × 10⁻⁸ |
| Comparative | Comparative | Tube | Not cleaned | — | 91 × 10⁻⁸ |
| Example 2 | Example 1 | | | | |
| Comparative | Comparative | Tube | Cleaned | XF | 45 × 10⁻⁸ |
| Example 3 | Example 1 | | | | |
| Comparative | Comparative | Bottle | Not cleaned | — | 377 × 10⁻⁸ |
| Example 4 | Example 1 | | | | |
| Comparative | Comparative | Bottle | Cleaned | SF10 | 176 × 10⁻⁸ |
| Example 5 | Example 1 | | | | |

TABLE 3

| | | Cleaning conditions for resin pellets | | | | Evaporation |
|---|---|---|---|---|---|---|
| | | | | Cleaning | | residue |
| | | | | agent/ | | (residue/ |
| | | | Cleaning | pellet | Drying | surface |
| | Resin | Cleaning | temperature | (weight | temperature | area) |
| | pellet | Agent | (° C.) | ratio) | (° C.) | mg/mm² |
| Example 16 | PFA (2) | SF10 | 110 | 0.2 | 150 | 10 × 10⁻⁶ |
| Example 17 | PFA (2) | SF10 | 110 | 0.5 | 150 | 9 × 10⁻⁶ |
| Comparative | PFA (2) | — | — | — | — | 12 × 10⁻⁶ |
| Example 6 | | | | | | |

### INDUSTRIAL APPLICABILITY

The resin pellets of the present invention are suitable as a molding material for molding a molded product that is used in semiconductor manufacturing and requires high cleanliness. Further, the molded product of the present invention is suitable as a molded product for liquid transfer liquid transfer or liquid contact that has high cleanliness and is used in semiconductor manufacturing.

1. A resin pellet comprising at least one selected from tetrafluoroethylene homopolymers or copolymers, wherein the evaporation residue after evaporating and drying the extract obtained by dissolving and extracting the fluorine-containing substance contained in or adhering to the resin pellet in a fluorine-containing extractant is 20×10⁻⁶ mg/mm² or less.

2. The resin pellet according to claim 1, wherein the evaporation residue is in a range of from 0 to 10⁻⁶ mg/mm².

3. The resin pellet according to claim 1, wherein the evaporation residue is in a range from 0 to 1.0×10⁻⁶ mg/mm².

4. The resin pellet according to claim 1, wherein the tetrafluoroethylene (TFE) copolymer is at least one of a TFE/hexafluoropropylene (HFP) copolymer (FEP), a TFE/perfluoro(alkyl vinyl ether) (PAVE) copolymer (PFA), an ethylene/TFE copolymer (ETFE), a TFE/HFP/PAVE copolymer, a TFE/HFP/vinylidene fluoride copolymer (THV), a TFE/ethylene/perfluorodimethyldioxole copolymer, a TFE/CF₂═CFOCF₂CF(CF₃)OCF₂CF₂SO₂F copolymer, or a mixture of any of these copolymers.

5. The resin pellet according to claim 1, wherein the fluorine-containing extractant is decafluoropentane.

6. A method for producing the resin pellet described in claim 1, the method comprising cleaning a resin pellet comprising at least one selected from tetrafluoroethylene homopolymers or copolymers with a fluorine-containing cleaning agent.

7. The method for producing a resin pellet according to claim 6, wherein the fluorine-containing cleaning agent is at least one selected from hydrofluorocarbons, perfluorocarbons, and fluorine-containing ethers.

8. The method for producing a resin pellet according to claim 6, wherein the cleaning with the fluorine-containing cleaning agent is followed by cleaning with an acid or alkaline solution.

9. A molded product comprising the resin pellet described in claim 1.

10. The molded product according to claim 9, wherein the evaporation residue after evaporating and drying the extract obtained by dissolving and extracting the fluorine-containing substance contained in or adhering to the molded product in a fluorine-containing extractant is 20×10⁻⁶ mg/mm² or less.

11. The molded product according to claim 9, wherein the molded product has a hollow portion.

12. The molded product according to claim 9, wherein the molded product has been cleaned with a fluorine-containing cleaning agent, or has been cleaned with a fluorine-containing cleaning agent, and then with an acid or alkaline solution.

13. The molded product according to claim 12, wherein the fluorine-containing cleaning agent is at least one selected from hydrofluorocarbons, perfluorocarbons, and fluorine-containing ethers.
